(19) United States
(12) Patent Application Publication
(10) Pub. No.: US 2018/0218306 A1
(43) Pub. Date: Aug. 2, 2018

(54) SYSTEM, METHOD AND COMPUTER PROGRAM PRODUCT FOR A COGNITIVE PROJECT MANAGER ENGINE

(71) Applicant: International Business Machines Corporation, Yorktown Heights, NY (US)

(72) Inventors: Daniela Rosu, Yorktown Heights, NY (US); Larisa Shwartz, Yorktown Heights, NY (US)

(73) Assignee: International Business Machines Corporation

(21) Appl. No.: 15/420,081

(22) Filed: Jan. 30, 2017

(51) Int. Cl. G06Q 10/06

(52) U.S. Cl. CPC G06Q 10/06375; G06Q 10/06313; G06Q 10/063118

(57) ABSTRACT

A computer-implemented information verification method, system, and computer program product, include identifying an issue exists or is likely to emerge in a project plan of a project based on a predicted deviation between data extracted from a project input compared with a project trajectory, predicating a cause and a degree of severity of the issue, determining a solution option for the issue and an impact of the solution option with respect to a function and a cost, implementing the solution option to adjust the project plan to ameliorate the issue and gradually return to the project trajectory.

### BACKGROUND

The present invention relates generally to a project management method, and more particularly, but not by way of limitation, to a system, method, and computer program product for customizing and training a cognitive project manager to perform actions for issue detection and to mitigate the issues by interacting and collaborating with the project team.

A project manager's (PM) work description spans a large set of activities, ranging in skill and volume requirements. Project manager's cost varies with project size. In complex projects, the Project manager's interactions involve a large group of people, diverse skills, and works scope. There is a high volume of tracking progress and larger than average volume of problem resolution resulting in the majority of the time spent by a project manager associated with overhead costs (e.g., ˜30% of cost is project management is overhead). Also, complex decisions involving multiple parties require project manager's expertise in the area of activity

Conventionally, in simple projects, project managers interact with small/consistent group of people and one project manager can potentially manage the project. However, project managers are typically involved in large projects that exceed the capability of a human to process solutions to issues that arise while executing a project plan as well as cause companies to incur great costs.

Thus, in order to reduce the cost of the project manager's activity and streamline project execution/solution implementation, there is a need in the art for a cognitive assessment of project status and decisions about project actions and knowledge.

### SUMMARY

In an exemplary embodiment, the present invention can provide a computer-implemented information verification method, the method including identifying an issue exists or is likely to emerge in a project plan of a project based on a predicted deviation between data extracted from a project input compared with a project trajectory, predicating a cause and a degree of severity of the issue, determining a solution option for the issue and an impact of the solution option with respect to a function and a cost, implementing the solution option to adjust the project plan to ameliorate the issue and gradually return to the project trajectory.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a high-level flow chart for a project management method 100 according to an embodiment of the present invention;

FIG. 2 depicts inputs and parties interactive with the project management method 100 according to an embodiment of the present invention;

FIG. 3 depicts a cloud computing node according to an embodiment of the present invention;

FIG. 4 depicts a cloud computing environment according to an embodiment of the present invention; and

FIG. 5 depicts abstraction model layers according to an embodiment of the present invention.

### DETAILED DESCRIPTION

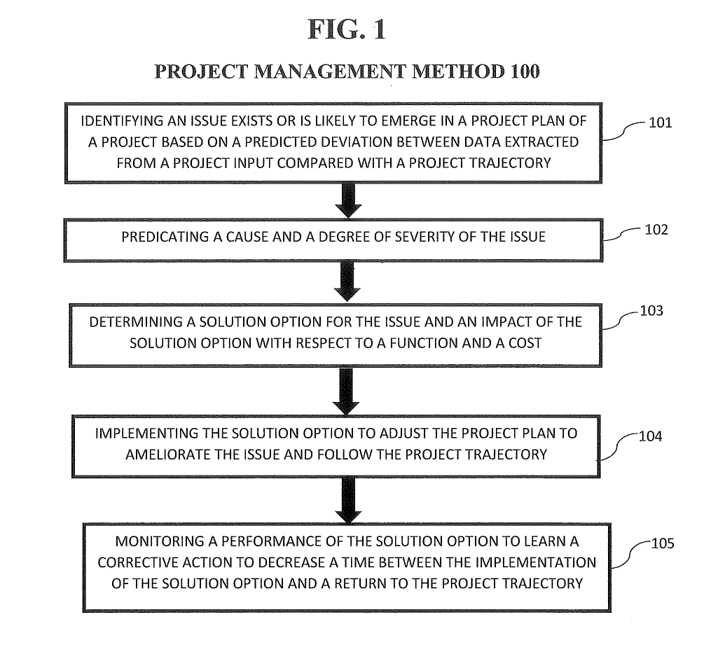

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

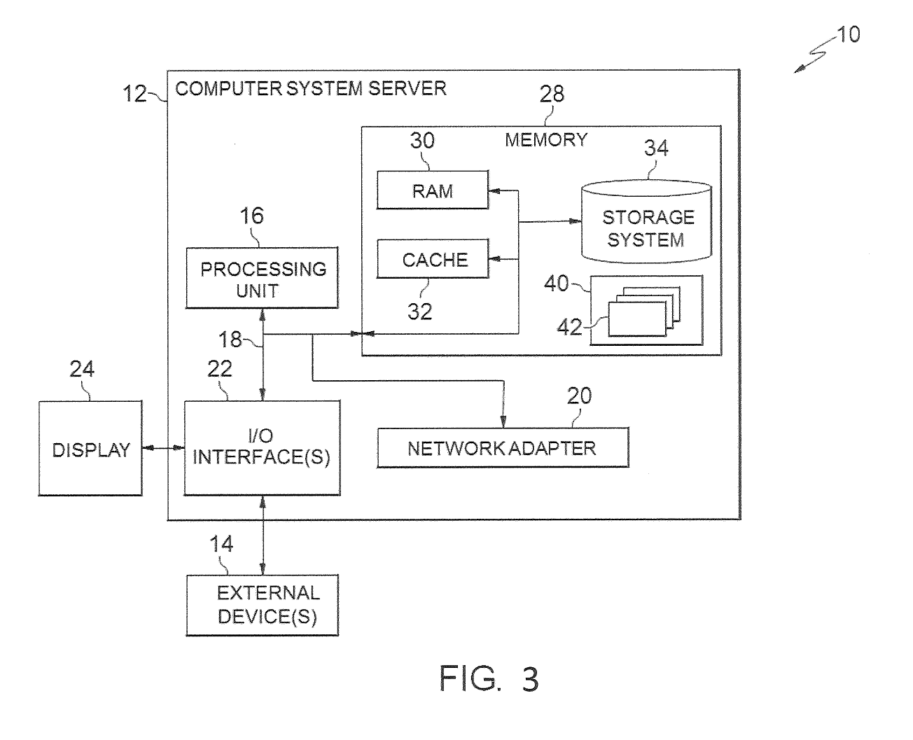

With reference now to FIG. 1, a project management method 100 according to an embodiment of the present invention includes various steps identify issues within the performance of a project plan of a project in order to determine solutions to return the project plan to the original project trajectory (i.e., reduce costs associated with inefficient project management). As shown in at least FIG. 3, one or more computers of a computer system 12 according to an embodiment of the present invention can include a memory 28 having instructions stored in a storage system to perform the steps of FIG. 1.

Thus, a project management method 100 according to an embodiment of the present invention may act in a more sophisticated and useful fashion, and in a cognitive manner while giving the impression of cognitive mental abilities and processes related to knowledge, attention, memory, judgment and evaluation, reasoning, and advanced computation. That is, a system is the to be “cognitive” if it possesses macro-scale properties—perception, goal-oriented behavior, learning/memory and action—that characterize systems (i.e., humans) that are generally agreed as cognitive.

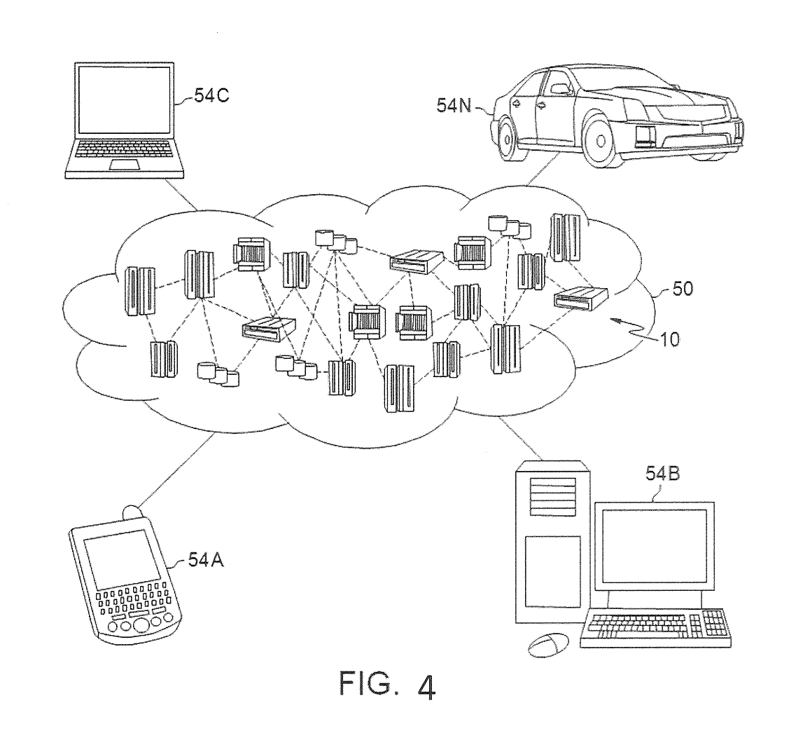

As will described/illustrated herein, one or more embodiments of the present invention (see e.g., FIGS. 3-5) may be implemented in a cloud environment 50 (see e.g., FIG. 4). It is nonetheless understood that the present invention can be implemented outside of the cloud environment.

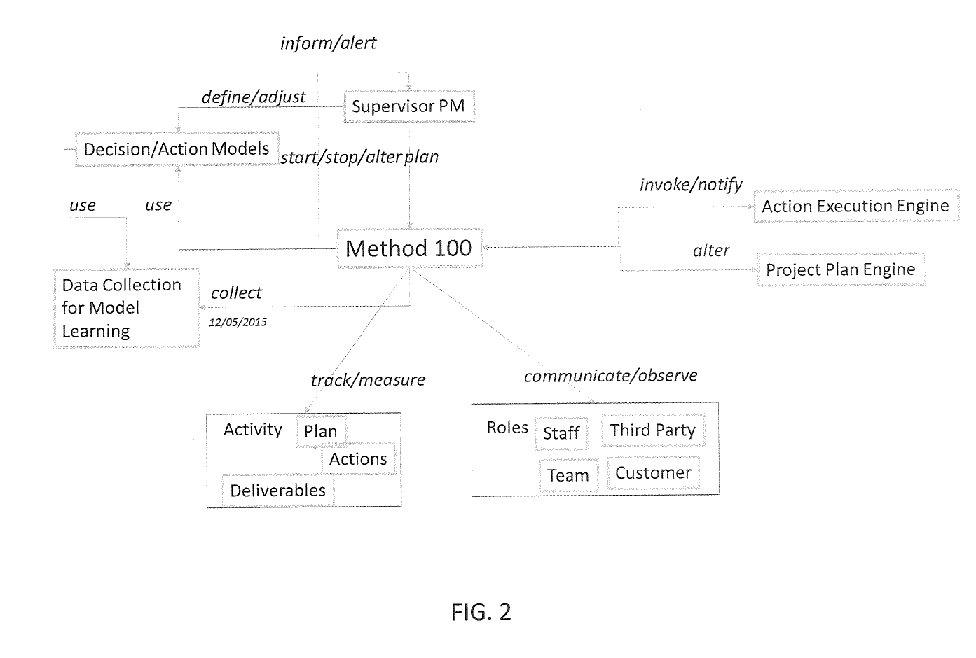

Referring now to FIGS. 1 and 2, in step 101, if an issue exists or is likely to emerge in a project plan of a project is identified based on a predicted deviation between data extracted from a project input compared with a project trajectory. In other words, the project trajectory of the project plan (i.e., such as a timeline of completion) is compared with the actual progress of the project plan from data extracted from a project input such as from a project manager, from software code written to date, from imaging of a construction site, from individual members of the staff inputting progress reports, etc. to determine if there is a deviation between the two (i.e., the project plan will complete later than the project trajectory). If there is a difference between the progress plan and the project trajectory, it is determined that an issue exists. Alternatively, if it is predicted that there is likely to be a deviation between the project plan and the project trajectory (i.e., a project lead gets sick and has to call out of work for a week), the issue is predicted as likely to emerge. For example, when a project lead calls out sick for a week, it is likely that their team will fall behind on their project plan.

For example, in step 101, the inputs can include a project plan, project staffing, a budget, etc. The actions and roles expected execution patterns as per initial staff assignment are adjusted based on a historical model of action/staff execution. Manual adjustments can be accepted from the project owner. During the project plan, periodically updating is performed to the actual activity execution pattern and actual expense pattern, using one or more techniques, such as process information pulled by questioner or submitted by staff in machine-readable template, monitoring activity in an artifact repository to determine deliverable completion, etc.

The artifact repository can model artifacts in a per-staff and per-role historical model of action execution (e.g., first week to 25% complete, second week to 75%, third staff week to 90%, fourth to 100%). Based on the action type, the parameters, role, and the actual, a natural language model can be used to identify the risk and issues in team communication such as chat, e-mail, etc. A threshold can be implemented to trigger deviation investigation. Also, the issue model can include a likelihood of causes of execution delays or expense overruns (e.g., a cause execution delay for development activity in order of likelihood can be an unavailability of test environment, staff out-of-office, design miss, staff overbooked, etc.). The model can be defined explicitly or can be inferred by from search in Issue-Cause knowledge base. The model can be estimated by a data mining tool.

Expenses in financial data sources can be monitored to assist in identifying the issue. For example, insights can be extracted by analyzing text, e-mail, etc. that project members exchange between them or with third party/customer related to the project. The insights are collected for future learning through offline or online learning methods. The risk analysis process is triggered if deviation of actual project progress (i.e. project plan) from expected project progress (i.e., project trajectory) is present or more than a threshold (action/staff specific). For example, this can be determined from customer-related communicating (e.g., direct email, voice transcripts, team logs 0 that a risk related to customer pre-requisites is likely occur—e.g., not ready in time with information about managed system, customer team changes or personnel availability) Triggers are collected by text analysis and compared with existing issue-cause knowledge base.

In step 102, a cause and a degree of severity of the issue is predicted. The cause or degree of severity can be determined based on action type, staff features, etc. using an issue model. For example, a survey can be automatically created about applicability and cause and related details for each possible cause and submit to related staff. The survey can be fulfilled in e-mail, a web application such as business process management, case management software, etc. Survey responses can be analyzed automatically. The cause or degree of severity can be determined as the most likely cause by integrating across responses (e.g., weighted voting method, summation and average method, etc.).

In step 103, a solution option can be determined for the issue and an impact of the solution option with respect to a function and a cost. The solution option can be determined by matching causes, a project type, and a project activity with prior solution patterns and by evaluating the solution options for the prior solution patterns and determine related project plan solution options.

The solution option can be based on an input of the project and activity details, a likely issue and expected cost overruns, likely causes of overruns, supporting insights collected from survey and text analysis of team communication, etc. A cause-resolution knowledge base can be searched for models (i.e., a cause-resolution model) that match the context of the project/activity. The results can be sorted based on expectation-of-impact score. The results are compared with a supervisor alert score to determine if problem should be escalated to a supervisor. If escalated, the supervisor can be alerted with pointer to issue/cause analysis context and wait notification of risk resolution or supervisor's selection of the resolution to enact (i.e., if the solution option results in a large spending increase for overtime, it is likely that the solution option is escalated to approve the additional costs). If no escalation, the solution option is process to the implementation step 104.

The cause-resolution model can include context to describe the applicability of the solution option (e.g., an activity type, customer type, etc.), expectations of Impact of the solution option expected values or distributions of project impact, a timing (e.g., back-on-track delay), additional costs, customer satisfaction risk, a team satisfaction (e.g., number of times the resolution was applied and was successful in the past through learning as described later), a supervisor override (e.g., a number of times solution applied and actions were canceled by supervisor), etc. The actions to be executed in the solution option can include, for example, hire new staff, compose and send a request to specific support team (e.g., internal or third-party) and monitor reply, provide information/guidance on specific task to specific role/staff in the team, setup team meeting, etc. The solution option can also include project plan changes to apply such as remove/add activity, add staff to role, extend/reduce execution duration/hours, add/remove resource quota, etc.

Also, the cause-resolution model used in the determining the solution option can output an expectation of Impact Score Model (i.e., a technique for prioritizing resolutions based on expectation of parameters such as a weighted average, a project specific model assigned by supervisor, etc. Also, the supervisor alert score for escalating to the supervisor for approval can be triggers when the expectation of impact is under a threshold for all solution options, when an increase in costs is associated with the solution option, etc.

In step 104, the solution option is implemented to adjust the project plan to ameliorate the issue and gradually return to the project trajectory. That is, the solution option is implemented for the team such that the deviation between the project plan and the project trajectory is gradually decreased to return to an on-time project. The implementing can implement the solution option by, for example, adjusting parameters in the project plan, adjusting a staffing for the project, and modifying deliverables in the project. The implementing can further disseminate (i.e., distribute) the solution option to individuals (i.e., team members) in the project affected by the solution option (i.e., their job changes as a result of the solution option).

That is, in step 104, the actions associated with a cause-resolution (i.e., solution option) selected from the cause-resolution model is implemented. For every action, an action descriptor can be composed with programmatically extracted parameters, an action execution engine with the action descriptor can be activated, parameters, execution options, as described in cause-resolution model can be invoked, the next action can be initiated upon return from previous invocation to execution engine, and notifications of action completion can be received to record the output, collect related measurements of performance indicators, etc. A Project Planning component can be triggered to adjust the project plan and invoke project planning with patterns of change defined for the resolution. Then, the new project plan is disseminated to ameliorate the issue.

The solution can be implemented by modeling an action descriptor to function to execute (e.g., API or code) with parameters as references to context elements such as project, action, issues, cause, etc. The action descriptor can account for time lag for measurable impact (e.g., how far after execution one expects to see some cost/progress impact).

The action execution engine can include an architecture component that executes on demand, one or more-step actions, using a programmatic API or interpretation of scripts embedded in request descriptor, embeds take action-descriptors and parameters, and execution options, and returns notification of completion, and/or results asynchronous or synchronous.

The project plan change pattern of the solution option can be based on, for example, a milestone (e.g., changed deadline), a role (e.g., replace staff or promote staff), staff (e.g., increase/decrease available hours for time interval), activity/staff (e.g., increase/decrease percent of utilization), activity/deadline or deliverables modification, activity (e.g., add/remove sub-activity), etc.

The project planning engine can include an architecture component that processes plan change requests and consolidates plan costs, timeline and other summaries, within the plan and across related plans.

In step 105, a performance of the solution option is monitored to learn a corrective action to decrease a time between the implementation of the solution option and a return to the project trajectory. The monitoring can learn the corrective action by testing a plurality of different solution options from the solution option to determine if a different solution option can decrease the time.

The knowledge related to the impact of executing the solution option is collected to inform future decisions by learning an effectiveness of the solution option and adjusting the later solution option decisions. The monitoring monitors the solution option by, for example, monitoring project progress and cost by role/staff while solution option is in progress, cost with other expense, related to the solution option implementation (e.g., paying an outside firm to hire new workers, increased costs associated with managing new workers, increased productivity with solution option, etc.), customer and team satisfaction metrics, etc. The benefit of the solution after solution option is completed or back-on-track time is determined by collecting input on staff utilization, project process, costs. The benefit is monitored to learn if a different solution option can increase the benefit.

Also, a training method of automated decision (i.e., automatically implementing the solution option) can be utilized by, for example, a bootstrap technique where a supervisor or industry/company expert best-practices are used to determine decision, a historical activity technique by data mining methods are applied to historical PM activity to determine some components of the model (e.g., types of causes, possible resolutions, likelihood of success, etc.), and a historical activity method where data mining models are created based on traces collected during Cognitive PM (CPM) activity monitoring or interaction with team for root cause assessment. Sample inputs include project status, communication cues, and correlated completion-time assessment of risk. Personal project-team models are created with respect to communication cues vs. issues, and completion pattern vs. issues. It is noted that the historical activity technique requires expert input to refine the catalog of project/action categories and determine specific execution process, e.g., resolution actions and plan revision.

Thus, the method 100 can automate the PM function of risk identification using cognitive models for qualification of a risk situation, automate the PM function of discovery of risk cause using cognitive models to trim the scope, and domain-specific Q&A models to qualify the most-likely cause, and automate the PM function of eliminating risk using cognitive models for cause resolution and action patterns with automated execution and tracking of impact.

Exemplary Hardware Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 3, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

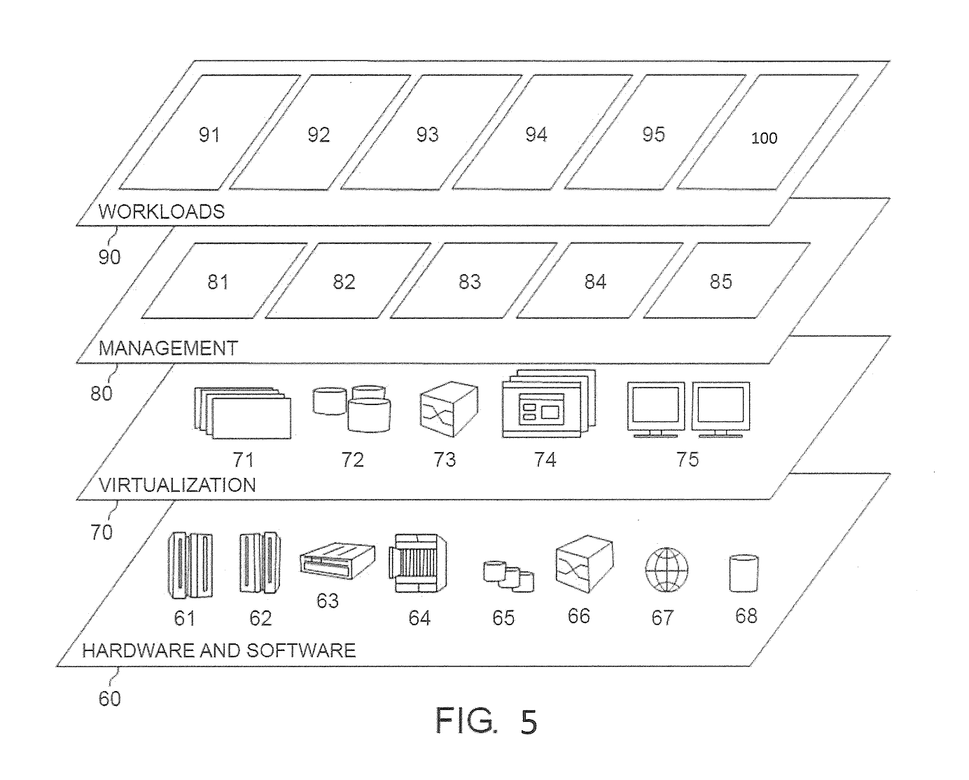

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the project management method 100.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented information analysis method, the method comprising:
identifying an issue exists or is likely to emerge in a project plan of a project based on a predicted deviation between data extracted from a project input compared with a project trajectory;
predicating a cause and a degree of severity of the issue;
determining a solution option for the issue and an impact of the solution option with respect to a function and a cost;
implementing the solution option to adjust the project plan to ameliorate the issue and gradually return to the project trajectory.

2. The computer-implemented method of claim 1, further comprising monitoring a performance of the solution option to learn a corrective action to decrease a time between the implementation of the solution option and a return to the project trajectory.

3. The computer-implemented method of claim 1, wherein the determining determines the solution option by:
matching causes, a project type, and a project activity with prior solution patterns; and
evaluating the solution options for the prior solution patterns and determine related project plan solution options.

4. The computer-implemented method of claim 1, wherein the implementing implements the solution option by:
adjusting parameters in the project plan;
adjusting a staffing for the project; and
modifying deliverables in the project,
wherein the implementing further disseminates the solution option to individuals in the project affected by the solution option.

5. The computer-implemented method of claim 1, wherein the monitoring learns the corrective action by testing a plurality of different solution options from the solution option to determine if a different solution option can improve the project trajectory.

6. The computer-implemented method of claim 1, wherein the identifying automates identification of the issue using a cognitive model for a qualification of an issue situation.

7. The computer-implemented method of claim 1, wherein the predicating discovers the cause and the degree of severity of the issue using a cognitive model to trim a scope and a domain-specific question and answer model for a project manager to answer to qualify a most-likely cause of the issue.

8. The computer-implemented method of claim 1, wherein the solution option eliminates the issue using a cognitive model for cause resolution and action patterns with automated execution and tracking of the impact.

9. The method of claim 1, embodied in a cloud-computing environment.

10. A computer program product for project management, the computer program product comprising a computer-readable storage medium having program instructions embodied therewith, the program instructions executable by a computer to cause the computer to perform:
identifying an issue exists or is likely to emerge in a project plan of a project based on a predicted deviation between data extracted from a project input compared with a project trajectory;
predicating a cause and a degree of severity of the issue;
determining a solution option for the issue and an impact of the solution option with respect to a function and a cost;
implementing the solution option to adjust the project plan to ameliorate the issue and gradually return to the project trajectory.

11. The computer program product of claim 10, further comprising monitoring a performance of the solution option to learn a corrective action to decrease a time between the implementation of the solution option and a return to the project trajectory.

12. The computer program product of claim 10, wherein the determining determines the solution option by:
matching causes, a project type, and a project activity with prior solution patterns; and
evaluating the solution options for the prior solution patterns and determine related project plan solution options.

13. The computer program product of claim 10, wherein the implementing implements the solution option by:
adjusting parameters in the project plan;
adjusting a staffing for the project; and
modifying deliverables in the project,
wherein the implementing further disseminates the solution option to individuals in the project affected by the solution option.

14. The computer program product of claim 10, wherein the monitoring learns the corrective action by testing a plurality of different solution options from the solution option to determine if a different solution option improve the project trajectory

15. The computer program product of claim 10, wherein the identifying automates identification of the issue using a cognitive model for a qualification of an issue situation.

16. The computer program product of claim 10, wherein the predicating discovers the cause and the degree of severity of the issue using a cognitive model to trim a scope and a domain-specific question and answer model for a project manager to answer to qualify a most-likely cause of the issue.

17. The computer program product of claim 10, wherein the solution option eliminates the issue using a cognitive model for cause resolution and action patterns with automated execution and tracking of the impact.

18. A project management system, the system comprising:
a processor; and
a memory, the memory storing instructions to cause the processor to perform:
identifying an issue exists or is likely to emerge in a project plan of a project based on a predicted deviation between data extracted from a project input compared with a project trajectory;
predicating a cause and a degree of severity of the issue;
determining a solution option for the issue and an impact of the solution option with respect to a function and a cost;
implementing the solution option to adjust the project plan to ameliorate the issue and gradually return to the project trajectory.

19. The system of claim 18, wherein the memory further stores instructions to cause the processor to perform:
monitoring a performance of the solution option to learn a corrective action to decrease a time between the implementation of the solution option and a return to the project trajectory.

20. The system of claim 18, embodied in a cloud-computing environment.
